(19) United States
(12) Patent Application Publication
(10) Pub. No.: US 2024/0070728 A1
(43) Pub. Date: Feb. 29, 2024

(54) INFORMATION PROCESSING DEVICE AND METHOD

(71) Applicant: TOYOTA JIDOSHA KABUSHIKI KAISHA, Aichi-ken (JP)

(72) Inventors: Hiroyuki OKAWARA, Nagoya-shi (JP); Masafumi FUJIO, Kobe-shi (JP); Koji TAKAHASHI, Tokyo (JP); Sho KOBAYASHI, Nagoya-shi (JP); Takahiro ICHINOSE, Nagoya-shi (JP)

(21) Appl. No.: 18/324,155

(22) Filed: May 26, 2023

(30) Foreign Application Priority Data
Aug. 23, 2022 (JP) 2022-132754

(51) Int. Cl. G06Q 30/02

(52) U.S. Cl. CPC G06Q 30/0278; G06Q 30/0284

(57) ABSTRACT

The information processing device determines whether or not to re-lease the first vehicle after returning from the lease. The information processing device includes a control unit. The control unit is configured to acquire, for the first vehicle, a evaluation result of a state according to a predetermined evaluation method, and output that the first vehicle is to be leased again when the evaluation result indicates that the first vehicle does not require repair, and output that the first vehicle is to be sold when the evaluation result indicates that the first vehicle needs repair.

### CROSS-REFERENCE TO RELATED APPLICATION

This application claims priority to Japanese Patent Application No. 2022-132754 filed on Aug. 23, 2022, incorporated herein by reference in its entirety.

### BACKGROUND

### 1. Technical Field

The present disclosure relates to an information processing device and a method.

### 2. Description of Related Art

A technique of calculating a lease fee for each unit period (for example, every month) based on a total lease amount and a scheduled lease period is known (for example, Japanese Unexamined Patent Application Publication No. 2022-067192 (JP 2022-067192 A)).

### SUMMARY

An object of the present disclosure is to provide an information processing device and a method capable of suppressing an increase in a storage period of a vehicle returned from being leased.

An information processing device according to an aspect of the present disclosure includes a control unit that executes:

acquiring an evaluation result of a state of a first vehicle returned from being leased, according to a predetermined evaluation method;
outputting that the first vehicle is targeted for lease again when the evaluation result indicates that the first vehicle does not need to be repaired; and
outputting that the first vehicle is targeted for sale when the evaluation result indicates that the first vehicle needs to be repaired.

A method according to another aspect of the present disclosure, the method being executed by a computer, includes

acquiring an evaluation result of a state of a first vehicle returned from being leased, according to a predetermined evaluation method;
outputting that the first vehicle is targeted for lease again when the evaluation result indicates that the first vehicle does not need to be repaired; and
outputting that the first vehicle is targeted for sale when the evaluation result indicates that the first vehicle needs to be repaired.

Further, still another aspect of the present disclosure is a program for causing a computer to execute a process in the information processing device or a system, or a storage medium in which the program is stored non-temporarily.

According to the present disclosure, it is possible to suppress the increase in the storage period of the vehicle returned from being leased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a system configuration of a vehicle management system according to a first embodiment;

FIG. 2 is an example of a hardware configuration of a server and a facility terminal;

FIG. 3 is an example of a functional configuration of a server;

FIG. 4 is an exemplary flow chart of a re-lease determination process of vehicles; and

FIG. 5 is an example of a storage management process of the vehicle of the server.

### DETAILED DESCRIPTION OF EMBODIMENTS

For example, if a vehicle after return from a lease is to be provided again to a lease of another contract, the returned vehicle may be stored in a storage space until the next lease contract is determined. Depending on the condition of the vehicle, repair may be required. In this case, the storage period of the vehicle to be repaired is prolonged by the period required for the repair. However, there is a limit to the storage space of the vehicle at the vendor's facility that provides vehicle leasing services. Therefore, it is not preferable that the storage space is occupied by the vehicle waiting for repair.

An aspect of the present disclosure is an information processing device that determines whether a first vehicle after returning from a lease can be provided to a lease again. The information processing device includes a control unit. The control unit acquires the evaluation result of the state of the first vehicle by a predetermined evaluation method. When the evaluation result indicates that the first vehicle does not need to be repaired, the control unit outputs that the first vehicle is to be leased again. The control unit outputs that the first vehicle is to be sold when the evaluation result indicates that the first vehicle needs to be repaired.

Examples of the information processing device include servers and Personal Computer (PC), tablets, and computers such as smart phones. The control unit is, for example, a processor such as a Central Processing Unit (CPU). The method of evaluating the state of the vehicle may be any of a well-known method, a method of evaluating the state of the vehicle by a vehicle leaser or a vehicle manager, or the like. The method of evaluating the state of the vehicle is not limited to a specific evaluation method. For example, with respect to the evaluation method of the state of the vehicle, it may be indicated that the evaluation result is a score, and the higher the score, the better the state. In this case, when the evaluation result is equal to or greater than the predetermined value, it is indicated that the vehicle does not need repair. For example, it may be indicated that the evaluation result is a rank and the higher the rank, the better the evaluation method of the state of the vehicle. In this case, when the evaluation result is equal to or higher than the predetermined rank, it is indicated that the vehicle does not need to be repaired. The subject of the rating of the vehicle's condition and the subject of repairs are, for example, those of the vehicle body, windows, mirrors, tires, wheels, and interiors to the extent that they can be visually identified. However, not limited thereto, the objects of assessment of the condition of the vehicle and the objects of repair may include, in addition to the extent that they can be visually confirmed, the components in the engine compartment and Electronic Control Unit (ECU) mounted on the vehicle.

For example, by receiving the evaluation result of the state of the first vehicle from another device, the control unit may acquire the evaluation result of the state of the first vehicle. Further, the control unit may acquire the evaluation result of the state of the first vehicle by calculating the evaluation result of the state of the first vehicle according to a predetermined evaluation method based on the information on the state of the first vehicle input from another device. In addition, the control unit may output, from the output device included in the information processing device, which of leasing or sale the first vehicle is targeted. In addition, the control unit may output whether the first vehicle is a lease or a sale target by transmitting to another device. When transmitting to another device, the other device serving as a transmission destination may be, for example, a transmission source device of information related to the state of the first vehicle. Alternatively, the other device serving as the transmission destination may be, for example, a device different from the transmission source device.

According to one aspect of the present disclosure, the first vehicle is again subject to a lease if no repair is required for the first vehicle after return from the lease. In this case, the first vehicle can immediately be provided to the lease again. Therefore, it is possible to suppress the prolongation of the period in which the first vehicle is stored in the storage space. Also, according to one aspect of the present disclosure, when the first vehicle after return from the lease requires repair, the first vehicle is subject to sale. Vehicles that are determined to be sold can be purchased or collected by used vehicle vendors, for example, even if the vehicle is in an unrepaired state. Therefore, when the first vehicle is to be sold, it is possible to suppress the prolongation of the period in which the first vehicle is stored in the storage space.

In one aspect of the present disclosure, when the traveling distance of the first vehicle is equal to or greater than the predetermined distance, the control unit may output that the first vehicle is to be sold regardless of the evaluation result. For example, a vehicle having a large travel distance tends to be less likely to be leased regardless of a state. Therefore, a vehicle having a large travel distance is highly likely to have a longer period of storage in the storage space as a lease target. According to one aspect of the present disclosure, in a case where the traveling distance of the first vehicle is equal to or more than the predetermined distance, it is possible to suppress the prolongation of the period in which the first vehicle is stored in the storage space by setting the first vehicle as the sales target.

In one aspect of the present disclosure, the control unit may output that the first vehicle is targeted for sale, regardless of the evaluation result, if it is predicted that the revenue in the case where the first vehicle is leased again is less than the predetermined value. Vehicles that are predicted to have a profit of less than a predetermined value due to leasing can quickly earn a profit by selling them as used vehicles. Further, it is possible to suppress the prolongation of the period of storage in the storage space.

In one aspect of the present disclosure, the control unit may output the change of the first vehicle to the sales target when the lease contract is not concluded even after a predetermined period of time has elapsed since the first vehicle is made to be the lease target again based on the evaluation result. Accordingly, it is possible to suppress the prolongation of the period in which the first vehicle is stored in the storage space.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

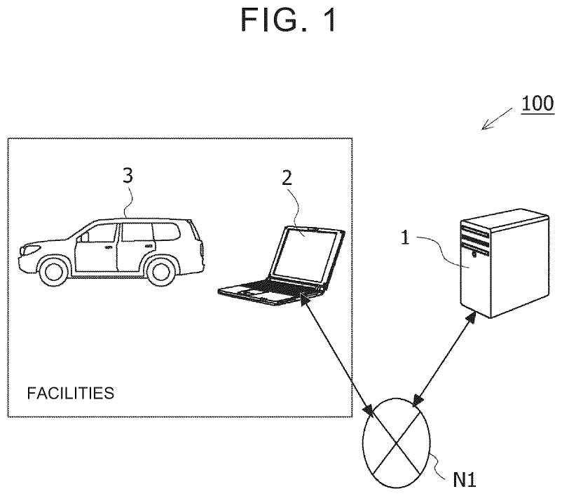

FIG. 1 is a diagram illustrating an example of a system configuration of a vehicle management system 100 according to a first embodiment. The vehicle management system 100 manages the returned vehicle 3 after the lease contract ends. The vehicle management system 100 includes a server 1 and a facility terminal 2. The facility terminal 2 is a terminal used in a facility that manages the vehicle 3. The facility in the first embodiment is a place where maintenance and sale or rental of the vehicle 3 is performed, such as a vehicle leaser, an automobile dealer, or an auction hall. The facility is provided with a storage space for storing a predetermined number of vehicles 3.

The servers 1 and the facility terminals 2 are connected to a network N1 and can communicate with each other. The network N1 may be, for example, a public network such as the Internet, a physical or virtual dedicated line, or a Local Area Network (LAN) laid in an establishment. In addition, the network N1 may include a telephone communication network such as a mobile phone network and a wireless communication network such as Wi-Fi (registered trademark).

Information on the state of the vehicle 3 is input to the facility terminal 2 by, for example, a staff member of the facility. In the first embodiment, information on the state of the vehicle 3 is acquired within a range that can be visually confirmed by the staff of the facility. Information regarding the state of the vehicle 3 includes, for example, information such as the size and number of scratches applied to the vehicle body, the window glass, the side mirror, the light, and the wheel, the size of the dent in the vehicle body, and the size of the fading or peeling of the paint on the vehicle body. The facility terminal 2 transmits information on the state of the vehicle 3 to the server 1. Note that the information regarding the state of the vehicle 3 is not limited to the information acquired within a range that can be visually confirmed.

The server 1 receives the information on the state of the vehicle 3 from the facility terminal 2, and determines whether or not the vehicle 3 can be provided to the lease again based on the information on the state of the vehicle 3. A criterion for determining whether or not the vehicle 3 can be provided to the lease again is whether or not the vehicle 3 needs to be repaired. When it is determined that the vehicle 3 does not need to be repaired, the server 1 determines to provide the vehicle 3 to the lease again. When it is determined that the vehicle 3 needs to be repaired, the server 1 determines that the vehicle 3 is sold as a used vehicle without providing the vehicle 3 to the lease again. Hereinafter, the provision to the lease again will also be referred to as the object of the lease. Sales as used vehicles are also referred to as sales targets.

Based on the evaluation result obtained by evaluating the state of the vehicle 3 by a predetermined method, the server 1 determines whether or not repair of the vehicle 3 is necessary. In the first embodiment, for example, the server 1 evaluates the state of the vehicle 3 from the information on the state of the vehicle 3 based on the evaluation criteria of the state of the vehicle defined by the administrator of the vehicle management system 100. The server 1 acquires a rating (score) as a rating result. In the evaluation method according to the first embodiment, it is assumed that the higher the score, the better the state of the vehicle 3. If the score is greater than or equal to the predetermined value, it is determined that the vehicle 3 does not need to be repaired. If the score is less than the predetermined value, it is determined that the vehicle 3 needs to be repaired. In the evaluation method according to the first embodiment, it is assumed that the score is a score of 5. In this case, the threshold value of the necessity of repair of the vehicle 3 is, for example, 4.5 points.

That is, in the first embodiment, when the score of the state of the vehicle 3 is equal to or greater than 4.5, the server 1 determines that the vehicle 3 is a lease target. When the score of the state of the vehicle 3 is less than 4.5, the server 1 determines that the vehicle 3 is an object to be sold. The server 1 transmits the determination result of whether or not the vehicle 3 can be re-leased to, for example, the facility terminal 2 or outputs the result to a predetermined output device. Note that the evaluation method of the vehicle 3 is not limited to a method in which the evaluation result is obtained. The evaluation method of the vehicle 3 may be, for example, a method in which a rank is obtained as an evaluation result. In this case, whether or not the vehicle 3 needs to be repaired is determined based on the rank.

In the first embodiment, based on the evaluation result of the state of the vehicle 3, it is determined whether the vehicle 3 is a lease target or a sale target. Thus, when the vehicle 3 does not need to be repaired, the vehicle 3 is provided to the lease as it is. That is, it is possible to suppress a prolongation of the storage period of the vehicle 3 in the storage space. When the vehicle 3 needs to be repaired, the vehicle 3 is sold as a used vehicle. For example, in a case where the vehicle 3 is picked up by the used vehicle seller in an unrepaired state, it is possible to suppress the prolongation of the storage period of the vehicle 3 in the storage space of the facility.

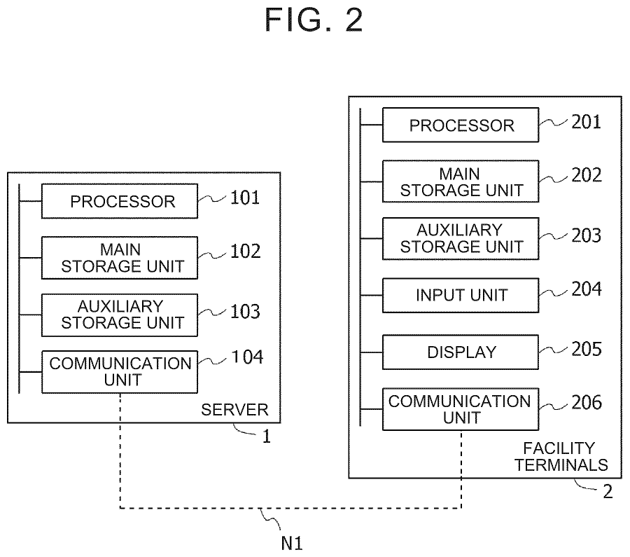

FIG. 2 is an example of a hardware configuration of the server 1 and the facility terminal 2. The servers 1 are computers such as PC or dedicated computers. The server 1 includes a processor 101, a main storage unit 102, an auxiliary storage unit 103, and a communication unit 104. The components are connected to each other by a bus. The server 1 is an example of an “information processing device”. The processor 101 is an example of a “control unit”. The main storage unit 102 and the auxiliary storage unit 103 are examples of “storage units”.

The processor 101 is, for example, a CPU or a Digital Signal Processor (DSP). The processor 101 controls the server 1 and performs calculation of various information processing. The main storage unit 102 is, for example, Random Access Memory (RAM) and Read Only Memory (ROM). The auxiliary storage unit 103 is, for example, Erasable Programmable ROM (EPROM), Hard Disk Drive (HDD), and a removable medium. The auxiliary storage unit 103 stores Operating System (OS), various programs, various tables, and the like. The processor 101 loads the program stored in the auxiliary storage unit 103 into a work area of the main storage unit 102 and executes the program. The components and the like are controlled through execution of the program. As a result, the server 1 realizes a function that matches a predetermined purpose. The main storage unit 102 and the auxiliary storage unit 103 are computer-readable recording media. Note that the server 1 may be a single computer or may be a combination of a plurality of computers.

The communication unit 104 communicates with the facility terminal 2 through a network N1. The communication unit 104 is, for example, a LAN interface board or a wireless communication circuit for wireless communication. The LAN interface board and the wireless communication circuit are connected to the network N1.

Next, the facility terminal 2 is, for example, a computer such as a smart phone, a mobile phone, a tablet terminal, a personal digital assistant, a wearable computer (smart watch or the like), or a PC.

The facility terminal 2 includes a processor 201, a main storage unit 202, an auxiliary storage unit 203, an input unit 204, a display 205, and a communication unit 206. The components are connected to each other by a bus. The processor 201, the main storage unit 202, and the auxiliary storage unit 203 of the facility terminal 2 are the same as those of the processor 101, the main storage unit 102, and the auxiliary storage unit 103 of the server 1. Therefore, descriptions thereof will be omitted.

The input unit 204 is a unit that receives an input operation performed by a user, and is, for example, a touch panel, a mouse, a keyboard, a microphone, or the like. The display 205 is a means for presenting information to a user. The display 205 is, for example, a Liquid Crystal Display (LCD) or a Electro luminescence (EL) panel. Note that the input unit 204 and the display 205 may be configured as a single touch panel display.

The communication unit 206 is a communication unit for connecting the facility terminal 2 to the network N1. The communication unit 206 uses, for example, a mobile communication service (for example, a telephone communication network such as 6th Generation (6G), 5th Generation (5G), 4th Generation (4G), 3rd Generation (3G), Long Term Evolution (LTE)), or a radio communication network such as Wi-Fi (registered trademark). The communication unit 206 is a circuit for communicating with another device (for example, the server 1 or the like) through the network N1 using these communication networks. The communication unit 206 may be a LAN interface board connected to a wired network. The hardware configuration of the server 1 and the facility terminal 2 shown in FIG. 2 is an example. The hardware configuration of the server 1 and the facility terminal 2 is not limited to the hardware configuration illustrated in FIG. 2.

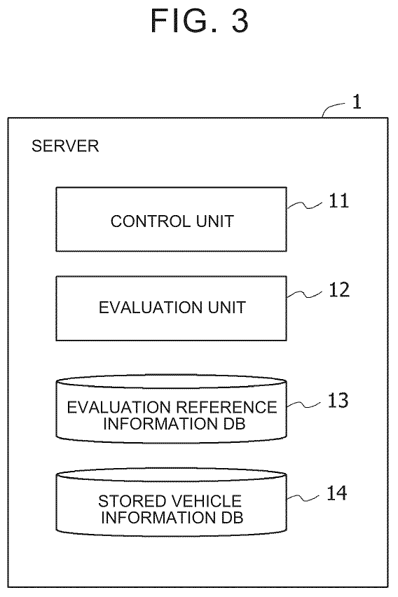

FIG. 3 is an example of a functional configuration of the server 1. The servers 1 include, as functional components, a control unit 11, an evaluation unit 12, an evaluation reference information DB 13, and a stored vehicle information DB 14. Processing of these functional configurations is achieved by the processor 101 of the server 1 executing a predetermined program.

The control unit 11 receives, from the facility terminal 2, information related to the vehicle 3 together with the re-lease determination request. In the re-lease determination request, a determination is made as to whether or not the vehicle 3 can be provided to the lease again. The information related to the vehicle 3 includes the type of the vehicle 3, the type, the date of manufacture, the travel distance, information related to the state of the vehicle 3, and the like. The control unit 11 outputs a rating request and information on the state of the vehicle 3 to the evaluation unit 12. The control unit 11 receives an input of a rating from the evaluation unit 12 as a response to the rating request. The server 1 determines whether or not the vehicle 3 can be provided to the lease again based on the score of the state of the vehicle 3. The server 1 transmits the re-lease determination result information to the facility terminal 2 by the vehicle 3. The re-lease determination result information indicates information related to a determination result of whether or not the information can be provided to the lease again. The re-lease determination result information of the vehicle 3 is a response to the re-lease determination request, and includes either information indicating that the vehicle 3 is a lease target or information indicating that the vehicle is a sales target.

In addition, in a case where the traveling distance of the vehicle 3 is equal to or more than the predetermined distance, and also in a case where it is assumed that the profit in a case where the vehicle 3 is leased is less than the predetermined value, the control unit 11 determines that the vehicle 3 is to be sold. In the first embodiment, for example, when the vehicle 3 is traveling for a hundred thousand kilometers or more, it is assumed that the traveling function of the engine or the like is deteriorated, or there is a high possibility that the vehicle is not selected by the user even if the vehicle is leased. Therefore, the vehicle 3 is not subject to leasing.

Whether or not the revenue in the case where the vehicle 3 is leased is less than the predetermined value is determined based on, for example, a value obtained by subtracting the cost incurred in providing the vehicle 3 to the lease from the revenue obtained in the case where the vehicle 3 is leased. The cost of providing the vehicle 3 to the lease is obtained, for example, by the sum of the depreciation cost in the contract period and the cost of vehicle inspection and repair. The depreciation cost in the contract period can be acquired from, for example, a residual value table indicating a change in the time series of the residual value of the vehicle. The revenue obtained when the vehicle 3 is leased is obtained, for example, as a sum of a value obtained by multiplying the monthly amount of the lease by the number of contract months and the application amount. The application fee may be set to, for example, six months of the monthly amount of the lease. The monthly lease fee for the vehicle is set in advance based on, for example, the size of the vehicle, the type of the vehicle, and the like, and is disclosed. Note that information such as a remaining price table, a monthly lease fee, and a cost for vehicle inspection and repair according to the type of the vehicle is stored in advance in the auxiliary storage unit 103.

When it is predicted that the revenue in the case where the vehicle 3 is leased is less than the predetermined value, the revenue is promptly obtained by setting the vehicle 3 as a sales target. Further, by making the vehicle 3 a target of sale, prolongation of the storage period of the vehicle 3 is suppressed.

The evaluation unit 12 evaluates the state of the vehicle 3. The evaluation unit 12 holds, for example, a calculation formula or a machine learning model according to the evaluation criteria defined by the administrator of the vehicle management system 100. The evaluation unit 12 inputs a value indicated by the information related to the state of the vehicle 3 to the parameter of the calculation formula or the machine learning model. The evaluation unit 12 acquires, as an output thereof, a rating of the state of the vehicle 3. The evaluation unit 12 outputs the evaluation of the state of the vehicle 3 to the control unit 11. In the first embodiment, the evaluation unit 12 acquires the score among the five-point scores as the score of the state of the vehicle 3.

The evaluation reference information DB 13 and the stored vehicle information DB 14 are created in the storage area of the auxiliary storage unit 103 of the server 1. The evaluation reference information DB 13 holds evaluation reference information on the condition of the vehicles 3 by the evaluation unit 12. The evaluation reference information held in the evaluation reference information DB 13 holds, for example, a plurality of items related to the status of the vehicles 3 and values corresponding to the respective items. The plurality of items related to the state of the vehicle 3 include, for example, items such as scratches of less than a predetermined size on the vehicle body, scratches of a predetermined size or more on the vehicle body, dents of less than a predetermined size on the vehicle body, and dents of a predetermined size or more on the vehicle body. Each field is assigned a value. For example, the evaluation unit 12 acquires the values of the items from the evaluation reference information held in the evaluation reference information DB 13 based on the information on the status of the vehicle 3. The evaluation unit 12 inputs the values of the respective items to a predetermined calculation formula or machine learning model, and acquires the evaluation of the state of the vehicle 3.

The stored vehicle information DB 14 stores stored vehicle information related to the vehicle 3 stored in the storage space of the facility of the vehicle management system 100. For example, the stored vehicle information includes identification information of the vehicle 3, identification information of a parking frame in which the vehicle 3 is stored, a re-lease determination result (lease or sale) of the vehicle 3, and information regarding a storage period of the vehicle 3. The information regarding the storage period of the vehicle 3 is, for example, the date and time when the vehicle 3 is stored in the storage space, the number of days elapsed since the vehicle 3 is stored in the storage space, or the like.

The control unit 11 registers the re-lease determination result of the vehicle 3 in the stored vehicle information DB 14. When a contract for leasing the vehicle 3 is concluded and the vehicle 3 is delivered, the control unit 11 deletes the stored vehicle information of the vehicle 3 from the stored vehicle information DB 14. In addition, the control unit 11 refers to the stored vehicle information DB 14 at predetermined timings such as once a day, once a week, and the like. When the vehicle 3 is the object of leasing and the storage period becomes equal to or longer than the predetermined period, the control unit 11 changes the result of the re-lease determination of the vehicle 3 from leasing to sales. The fact that the storage period is equal to or longer than the predetermined period indicates that the lease contract has not been concluded even after the predetermined period has elapsed for the vehicle 3. The change of the result of the re-lease determination from the lease of the vehicle 3 to the sale is transmitted to a predetermined device such as the facility terminal 2, for example, and is notified to the staff. The functional configuration of the server 1 is not limited to the example illustrated in FIG. 3.

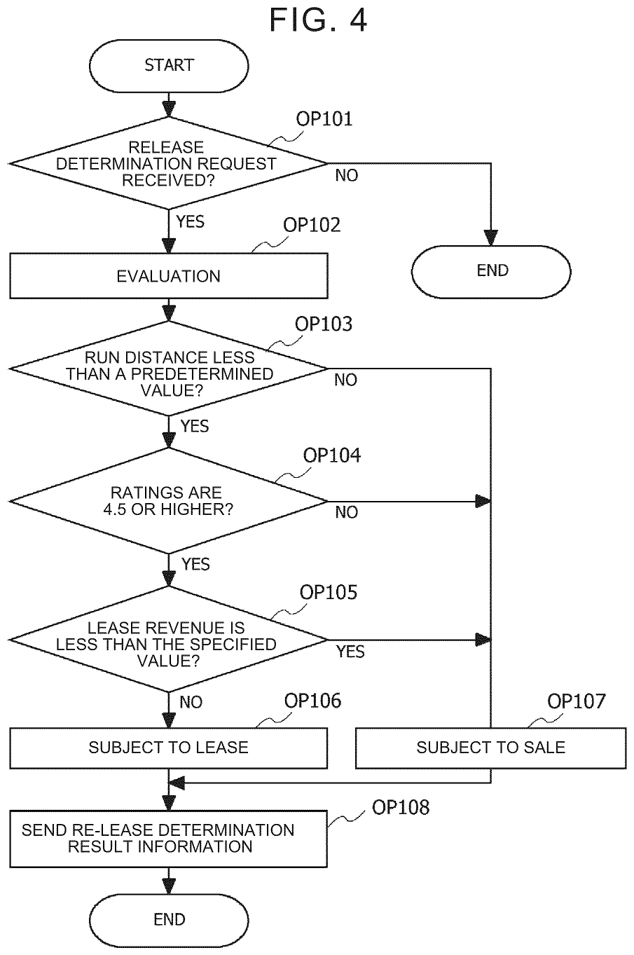

FIG. 4 is an example of a flowchart of a re-lease determination process of the vehicle 3 performed by the server 1. The processing illustrated in FIG. 4 is repeatedly executed at a predetermined cycle, for example. Although the processor 101 of the server 1 is the execution subject of the processing illustrated in FIG. 4, for convenience, the functional components will be mainly described.

In OP101, the control unit 11 determines whether or not a re-lease determination request has been received from the facility terminal 2. If a re-lease determination is received (OP101: YES), the process proceeds to OP102. When the re-lease determination is not received (OP101: NO), the process illustrated in FIG. 4 ends.

In OP102, the control unit 11 outputs a rating demand for the condition of the vehicles 3 to the evaluation unit 12. The control unit 11 acquires a rating as a rating result of the state of the vehicle 3 from the evaluation unit 12. In OP103, the control unit 11 determines whether or not the travel distance of the vehicles 3 is less than a predetermined distance. When the travel distance of the vehicles 3 is less than the predetermined distance (OP103: YES), the process proceeds to OP104. When the traveling distance of the vehicles 3 is equal to or greater than the predetermined distance (OP103: NO), the process proceeds to OP107.

In OP104, the control unit 11 determines whether or not the score of the condition of the vehicles 3 is equal to or greater than 4.5. When the score of the condition of the vehicle 3 is 4.5 or more (OP104: YES), the process proceeds to OP105. If the score of the condition of the vehicle 3 is less than 4.5 (OP104: NO), the process proceeds to OP107.

In OP105, the control unit 11 determines whether or not the revenue obtained when the vehicles 3 are provided to the lease is predicted to be less than a predetermined value. If it is predicted that the revenue when the vehicles 3 are provided to the lease is less than the predetermined value (OP105: NO), the process proceeds to OP106. If it is predicted that the revenue when the vehicles 3 are provided to the lease is equal to or greater than the predetermined value (OP105: YES), the process proceeds to OP107.

In OP106, the control unit 11 determines that the vehicles 3 are to be leased. The control unit 11 generates re-lease determination result information including information indicating that the vehicle 3 is a lease target. In OP107, the control unit 11 determines that the vehicles 3 are targets of sales. The vehicle 3 generates re-lease determination result information including information indicating that the vehicle is to be sold. In OP106 and OP107, the control unit 11 registers the re-lease determination-result information in the stored vehicle information DB 14. In OP108, the control unit 11 transmits the re-lease determination result information about the vehicle 3 to the facility terminal 2. After that, the process shown in FIG. 4 ends.

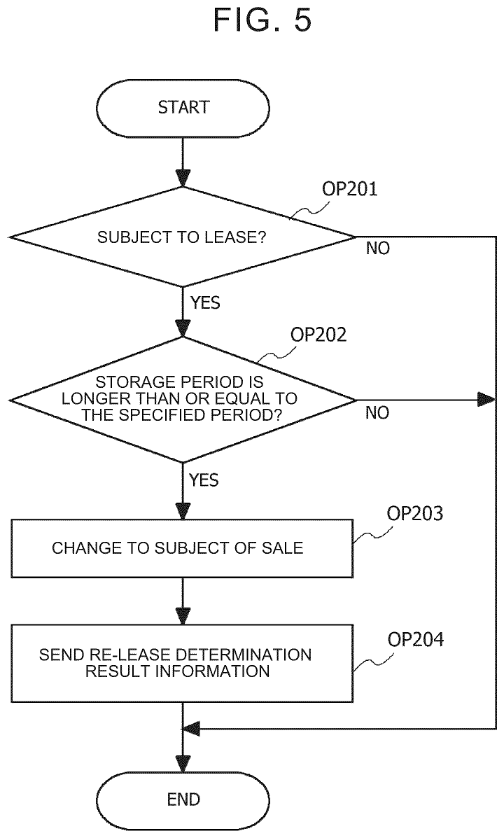

FIG. 5 is an example of a storage management process of the vehicle 3 of the server 1. The process illustrated in FIG. 5 is executed at a predetermined date and time, for example, once a day or in a cycle such as once a week. The process illustrated in FIG. 5 is executed for the vehicles 3 stored in the storage space, in which the stored vehicle information is stored in the stored vehicle information DB 14.

In OP201, the control unit 11 determines whether or not the vehicle 3 (hereinafter, the target vehicle) stored in the storage space is a leasing target. When the target vehicle is the leasing target vehicle (OP201: YES), the process proceeds to OP202. When the target vehicle is a target of sale (OP201: NO), the process illustrated in FIG. 5 ends.

In OP202, the control unit 11 determines whether or not the storage period of the target vehicles is equal to or longer than a predetermined period. When the storage period of the target vehicles is equal to or longer than the predetermined period (OP202: YES), the process proceeds to OP203. When the storage period of the target vehicles is less than the predetermined period (OP202: NO), the process illustrated in FIG. 5 ends.

In OP203, the control unit 11 changes the target vehicles from the leasing target to the sales target. The control unit 11 updates the stored vehicle information of the target vehicle in the stored vehicle information DB 14. In OP204, the control unit 11 transmits, to the facility terminal 2, the re-lease determination-result information including information indicating that the target vehicle is a sales target. After that, the processing shown in FIG. 5 is terminated.

### Action Effect of First Embodiment

In the first embodiment, it is determined whether the vehicle 3 returned from the lease is the object of the lease or the object of the sale based on the necessity of the repair. When no repair is required, the vehicle 3 is determined to be a lease target. As a result, the vehicle is provided to the lease again, and the storage period of the vehicle in the storage space can be suppressed from being prolonged. When a repair is required, the vehicle 3 is determined to be an object to be sold. As a result, for example, the vehicle is collected or purchased by a used vehicle seller or the like without repairing the vehicle, and thus it is possible to suppress the prolongation of the storage period of the vehicle in the storage space. That is, according to the first embodiment, it is possible to suppress the prolongation of the storage period in the storage space of the vehicle 3 returned from the lease of the vehicle management system 100.

In the first embodiment, information on the vehicle 3 is transmitted from the facility terminal 2 to the server 1, and the server 1 evaluates the state of the vehicle 3, but the present disclosure is not limited thereto. For example, the evaluation of the state of the vehicle 3 may be performed by a device other than the server 1 such as the facility terminal 2, and the evaluation of the state of the vehicle 3 may be transmitted from the facility terminal 2 to the server 1 as one of the pieces of information related to the vehicle 3.

Further, the re-lease determination process of the vehicle 3 returned from the lease described in the first embodiment can also be applied to determination of whether or not the vehicle used in the rental service and the share car service of the vehicle can be provided to the service again.

### OTHER EMBODIMENTS

The above-described embodiments are merely examples, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit that executes:
acquiring an evaluation result of a state of a first vehicle returned from being leased, according to a predetermined evaluation method;
outputting that the first vehicle is targeted for lease again when the evaluation result indicates that the first vehicle does not need to be repaired; and
outputting that the first vehicle is targeted for sale when the evaluation result indicates that the first vehicle needs to be repaired.

2. The information processing device according to claim 1, wherein when a travel distance of the first vehicle is equal to or greater than a predetermined distance, the control unit outputs that the first vehicle is targeted for the sale regardless of the evaluation result.

3. The information processing device according to claim 1, wherein when a prediction is made that a profit in a case where the first vehicle is leased again is less than a predetermined value, the control unit outputs that the first vehicle is targeted for the sale regardless of the evaluation result.

4. The information processing device according to claim 1, wherein the control unit outputs that the first vehicle is changed to a target for the sale when a lease contract is not concluded even after a predetermined period elapses since the first vehicle is targeted for the lease again based on the evaluation result.

5. A method executed by a computer, the method comprising:
acquiring an evaluation result of a state of a first vehicle returned from being leased, according to a predetermined evaluation method;
outputting that the first vehicle is targeted for lease again when the evaluation result indicates that the first vehicle does not need to be repaired; and
outputting that the first vehicle is targeted for sale when the evaluation result indicates that the first vehicle needs to be repaired.
